(19) United States
(12) Patent Application Publication
(10) Pub. No.: US 2021/0185050 A1
(43) Pub. Date: Jun. 17, 2021

(54) SYSTEMS AND METHODS FOR USING ACTIVE DIRECTORY DYNAMIC GROUP MEMBERSHIP ENGINES TO GRANT ACCESS

(71) Applicant: JPMORGAN CHASE BANK, N.A., New York, NY (US)

(72) Inventors: Stephen ROSMANN, Katy, TX (US); Lindsey BARBER, Mesa, AZ (US); Pradeep JONNALAGADDA, Hyderabad (IN); Hunter MITCHELL, Montgomery, TX (US)

(21) Appl. No.: 17/118,153

(22) Filed: Dec. 10, 2020

(30) Foreign Application Priority Data
Dec. 12, 2019 (IN) 201911051642

(51) Int. Cl. H04L 29/06

(52) U.S. Cl. CPC H04L 63/104; H04L 63/108; H04L 63/102

(57) ABSTRACT

Systems and methods for using active directory dynamic group membership engines to grant access are disclosed. In one embodiment, in an active directory dynamic group membership engine comprising at least one computer processor, a method for using active directory dynamic group membership engines to grant access may include: (1) receiving from a user electronic device, a request for privileged access to access a resource; (2) decisioning and granting the request for privileged access to the resource; (3) adding the user to an active directory group for privileged access to the resource, wherein the privileged access is limited to a time period; and (4) removing the user from the active directory group for privileged access upon expiration of the time period.

### RELATED APPLICATIONS

This application claims priority to, and the benefit of Indian Patent Application No. 201911051642, filed Dec. 12, 2019, the disclosure of which is hereby incorporated, by reference, in its entirety.

### BACKGROUND OF THE INVENTION

### 1. Field of the Invention

Embodiments are generally directed to systems and methods for using active directory dynamic group membership engines to grant access.

### 2. Description of the Related Art

Legacy storage devices will not accept sophisticated modern authentication solutions, like Sophia and ADFS, that offer traceability of logins and events. Additional instrumentation is necessary to limit standing privileged access to devices and at the same time offer traceability of activities on the devices as required for PCI compliance.

### SUMMARY OF THE INVENTION

Systems and methods for using active directory dynamic group membership engines to grant access are disclosed. In one embodiment, in an active directory dynamic group membership engine comprising at least one computer processor, a method for using active directory dynamic group membership engines to grant access may include: (1) receiving from a user electronic device, a request for privileged access to access a resource; (2) decisioning and granting the request for privileged access to the resource; (3) adding the user to an active directory group for privileged access to the resource, wherein the privileged access may be limited to a time period; and (4) removing the user from the active directory group for privileged access upon expiration of the time period.

In one embodiment, the request may be decisioned automatically.

In one embodiment, a user identifier for the user may be added to the active directory group for privileged access.

In one embodiment, the method may further include recording user activities associated with the privileged access to the resource.

In one embodiment, the user activities may be mapped to a user id for the user.

In one embodiment, the resource may include a block storage appliance or a block storage application.

In one embodiment, the access request may be in response to a trouble ticket, and the access request may be automatically generated in response to a trouble ticket.

In one embodiment, the time period may be based on a task to be performed, a security level of the resource, etc.

According to another embodiment, an active directory dynamic group membership system may include: an active directory dynamic group membership engine comprising at least one computer processor; a mapping database; and a resource. The active directory dynamic group membership engine receives, from a user electronic device, a request for privileged access to access the resource; may grant the request for privileged access to the resource; may add the user to an active directory group for privileged access to the resource by adding a user id to a mapping database, wherein the privileged access may be limited to a time period; and may remove the user from the active directory group for privileged access by removing the user id from the mapping database upon expiration of the time period.

In one embodiment, the active directory dynamic group membership engine may decision the request automatically.

In one embodiment, the active directory dynamic group membership engine may receive authorization for the request.

In one embodiment, the active directory dynamic group membership engine may record user activities associated with the privileged access to the resource.

In one embodiment, the user activities may be mapped to the user id.

In one embodiment, the resource may include a block storage appliance or a block storage application.

In one embodiment, the access request may be in response to a trouble ticket, and the access request may be automatically generated in response to a trouble ticket.

In one embodiment, the time period may be based on a task to be performed, a security level of the resource, etc.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 depicts a system for using active directory dynamic group membership engines to grant access according to one embodiment;

FIG. 2 depicts a method for using active directory dynamic group membership engines to grant access according to one embodiment;

FIG. 3 depicts an exemplary user interface according to one embodiment;

FIG. 4 depicts an exemplary user interface according to another embodiment; and

FIG. 5 depicts an exemplary user interface according to another embodiment.

### DETAILED DESCRIPTION OF PREFERRED EMBODIMENTS

Systems and methods for using active directory dynamic group membership engines to grant access are disclosed. Embodiments are directed to managing privileged access while maintaining Payment Card Industry (PCI) compliance. Embodiments are directed to an Active Directory Dynamic Group Membership Engine that adds and removes users from active directory (AD) groups based on trouble tickets and manager approval. Embodiments limit privileged access to specific environments, requires manager pre-approval for privileged access, ensures actions are easily traceable to a user, and grants temporary access to applications on an as-needed basis.

Embodiments may provide some or all of the following: commands executed may be traceable back to a user except when a functional identifier is necessary; (2) embodiments may not allow standing access to broad environments; (3) embodiments may rotate authentication credentials periodically (e.g., every 60 seconds); (4) embodiments resolve access management issues to appliances and applications that do not integrate with other solutions; and (5) embodiments may provide user group mappings to a certification process.

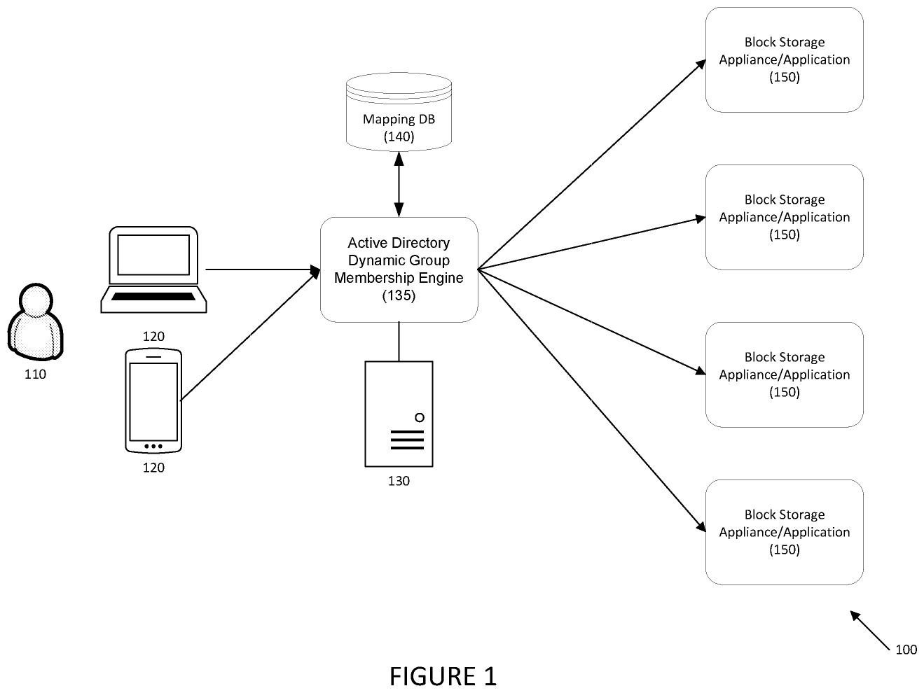

Referring to FIG. 1, a system for using active directory dynamic group membership engines to grant access is disclosed according to an embodiment. System 100 may include user 110 that may submit a request to access one or more resource, such as a block storage appliance/application 150 using electronic device 120. User 110 may submit request to active directory dynamic group membership engine 135, which may be hosted by server 130. Server 130 may be a physical server, a cloud-based server, combinations thereof, etc.

In one embodiment, active directory dynamic group membership engine 135 may write mappings of users to entitlements in mapping database 140.

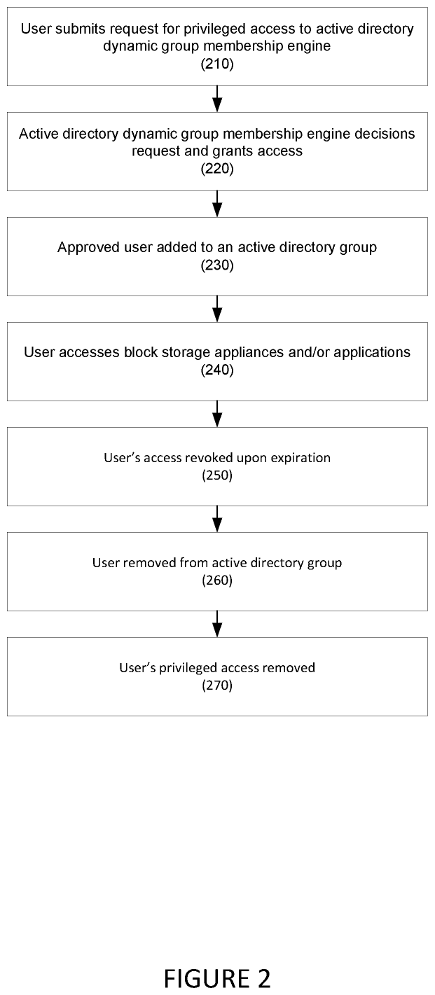

Referring to FIG. 2, a method for using active directory dynamic group membership engines to grant access is disclosed according to an embodiment. In step 210, a user may submit a request for privileged access to access one or more resource, such as block storage appliances and/or applications, to an active directory dynamic group membership engine.

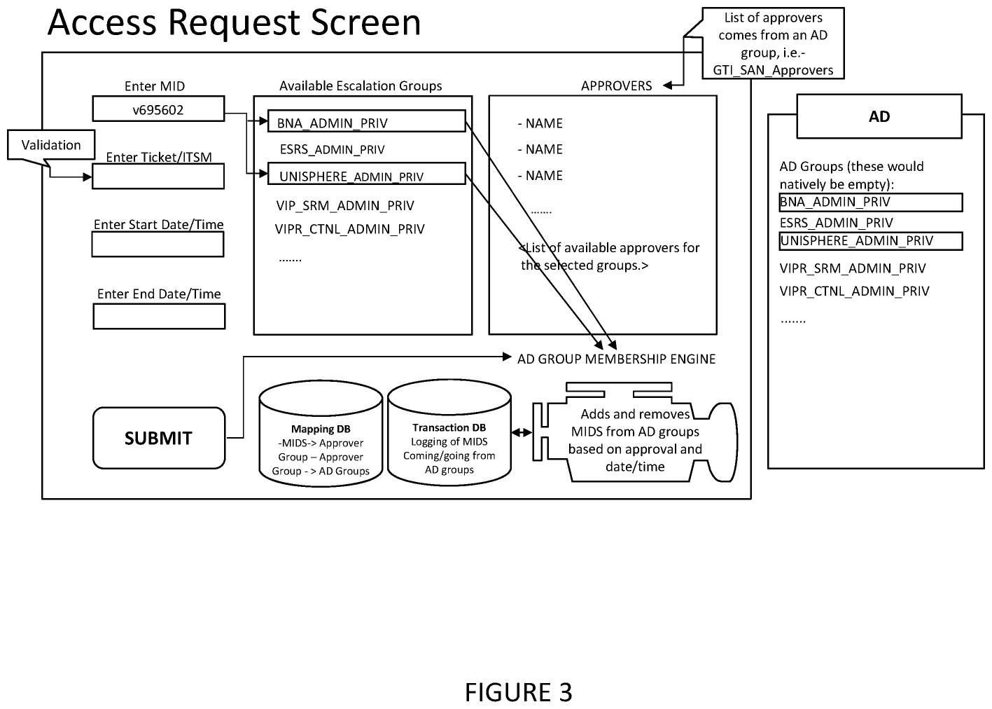

An exemplary access request screen is illustrated in FIG. 3.

In one embodiment, the access request is in response to a trouble ticket. For example, the access request may be automatically generated in response to a trouble ticket.

Referring again to FIG. 2, in step 220, the active directory dynamic group membership engine may decision and grant the access. In one embodiment, the decisioning may be automated; in another embodiment the decisioning may be manual. In still another embodiment, a combination of automated and manual decisioning may be used.

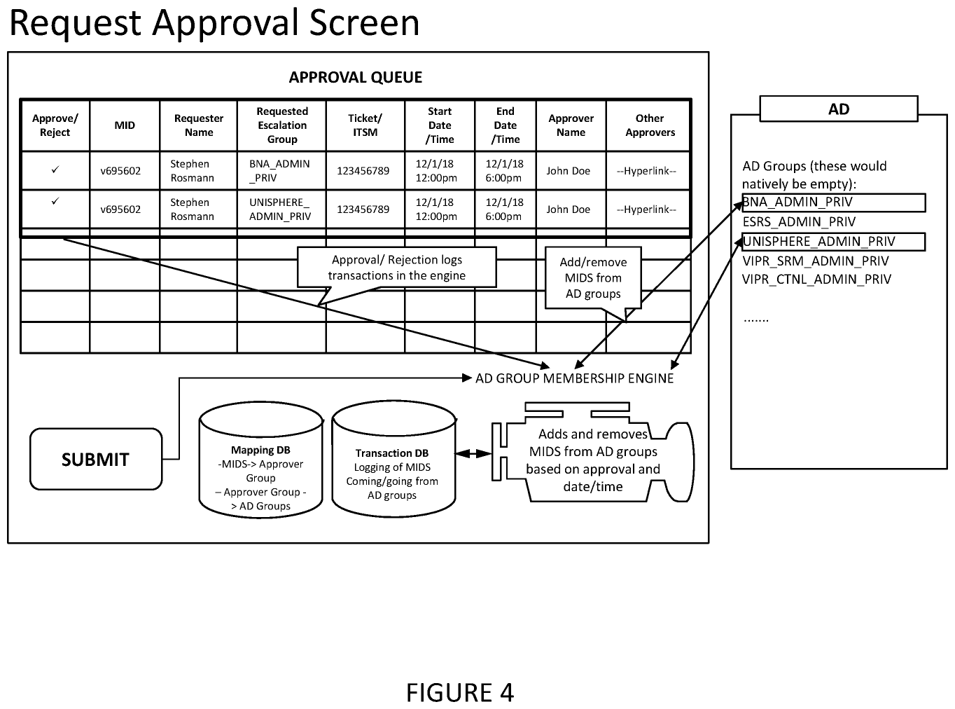

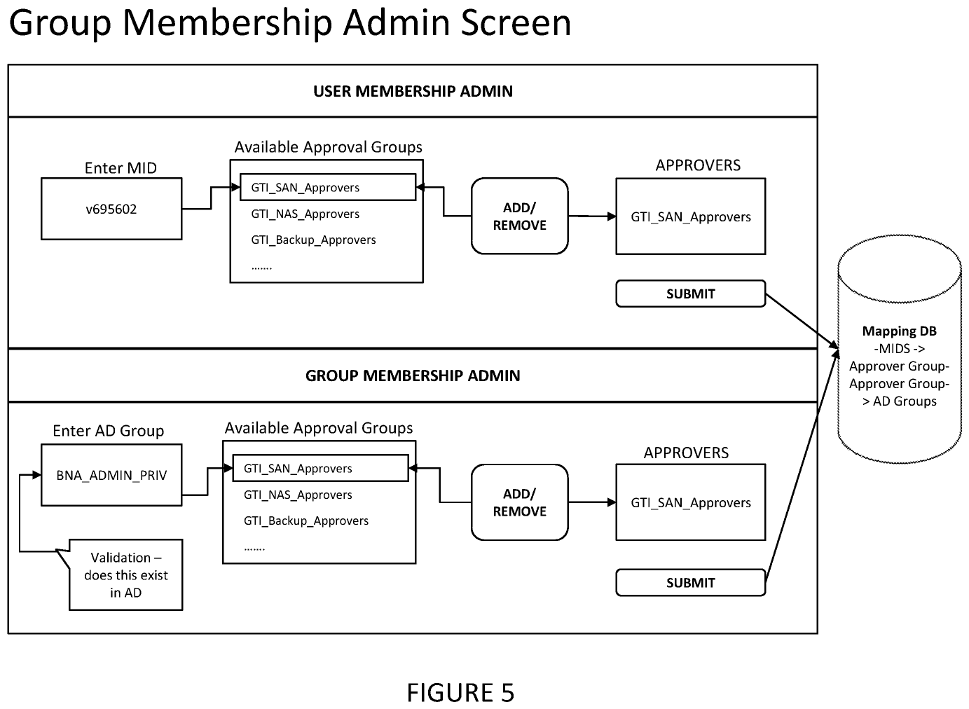

An exemplary request approval screen is provided in FIG. 4, and FIG. 5 depicts an exemplary group membership admin screen.

Referring again to FIG. 2, in step 230, the approved user may be added to an active directory group, and the access may be time limited. In embodiment, the access may be limited to 60 seconds, an hour, a day, etc. The length of the access may be based on the task to be performed, the security level of the resource, etc.

For example, the user's user id may be added to the active directory group for privileged access. In another embodiment, the user id may be a standard ID (“SID”), a management ID (“MID”), etc. For example, a MID may be assigned to a user, wherein as a FID may be assigned to a device or an application.

In one embodiment, the user id may be added to a mapping database, which may map the user id to the active directory group.

In step 240, the user may use the access to access the resource(s), such as the block storage appliances and/or applications. In one embodiment, user's activities with the resources may be stored and associated with the user id. For example, the user's activities may be associated with the user id and may be stored in a database. This may be, for example, for audit purposes.

In step 250, upon expiration of the privileged access, the user's access is revoked, and in step 260, the user is removed from the active directory group. For example, the user's user id may be removed from the active directory group for privileged access. In one embodiment, the user id may be removed from the mapping database.

In step 270, the user's privileged access is removed.

Hereinafter, general aspects of implementation of the systems and methods of the invention will be described.

The system of the invention or portions of the system of the invention may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the iOS operating system, the OS X operating system, the Android operating system, the Microsoft Windows™ operating systems, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for using active directory dynamic group membership engines to grant access, comprising:
in an active directory dynamic group membership engine comprising at least one computer processor:
receiving from a user electronic device, a request for privileged access to access a resource;
decisioning and granting the request for privileged access to the resource;
adding the user to an active directory group for privileged access to the resource, wherein the privileged access is limited to a time period; and
removing the user from the active directory group for privileged access upon expiration of the time period.

2. The method of claim 1, wherein the request is decisioned automatically.

3. The method of claim 1, wherein a user identifier for the user is added to the active directory group for privileged access.

4. The method of claim 1, further comprising recording user activities associated with the privileged access to the resource.

5. The method of claim 4, wherein the user activities are mapped to a user id for the user.

6. The method of claim 1, wherein the resource comprises a block storage appliance or a block storage application.

7. The method of claim 1, wherein the access request is in response to a trouble ticket.

8. The method of claim 1, wherein the access request is automatically generated in response to a trouble ticket.

9. The method of claim 1, wherein the time period is based on a task to be performed.

10. The method of claim 1, wherein the time period is based on a security level of the resource.

11. An active directory dynamic group membership system comprising:
an active directory dynamic group membership engine comprising at least one computer processor;
a mapping database; and
a resource;
wherein:
the active directory dynamic group membership engine receives, from a user electronic device, a request for privileged access to access the resource;
the active directory dynamic group membership engine grants the request for privileged access to the resource;
the active directory dynamic group membership engine adds the user to an active directory group for privileged access to the resource by adding a user id to a mapping database, wherein the privileged access is limited to a time period; and
the active directory dynamic group membership engine removes the user from the active directory group for privileged access by removing the user id from the mapping database upon expiration of the time period.

12. The system of claim 11, where the active directory dynamic group membership engine decisions the request automatically.

13. The system of claim 11, where the active directory dynamic group membership engine receives authorization for the request.

14. The system of claim 11, wherein the active directory dynamic group membership engine records user activities associated with the privileged access to the resource.

15. The system of claim 14, wherein the user activities are mapped to the user id.

16. The system of claim 11, wherein the resource comprises a block storage appliance or a block storage application.

17. The system of claim 11, wherein the access request is in response to a trouble ticket.

18. The system of claim 11, wherein the access request is automatically generated in response to a trouble ticket.

19. The system of claim 11, wherein the time period is based on a task to be performed.

20. The system of claim 11, wherein the time period is based on a security level of the resource.
